(19) United States
(12) Patent Application Publication
(10) Pub. No.: US 2012/0092683 A1
(43) Pub. Date: Apr. 19, 2012

(54) IMAGE FORMING APPARATUS AND DOCUMENT EDITING METHOD

(75) Inventor: Takaharu Ouchi, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/268,136

(22) Filed: Oct. 7, 2011

Related U.S. Application Data
(60) Provisional application No. 61/392,735, filed on Oct. 13, 2010.

(51) Int. Cl. G06K 15/02

(52) U.S. Cl. 358/1.2

(57) ABSTRACT

An image forming apparatus that can efficiently execute space reduction of a document file is provided. The image forming apparatus includes: a file designating unit which designates a document file; a document file acquiring unit which acquires the document file designated by the file designating unit, from a storage area; a setting information acquiring unit which acquires setting information of processing to change the size of a space in the document file acquired by the document file acquiring unit, from a setting information storage area; and a space processing control unit which performs the processing to change the size of a space in the document file acquired by the document file acquiring unit, based on the setting information acquired by the setting information acquiring unit.

### CROSS-REFERENCE TO RELATED APPLICATIONS

This application is based upon and claims the benefit of priority from U.S. provisional application 61/392,735, filed on Oct. 13, 2010; the entire contents all of which are incorporated herein by reference.

### FIELD

Embodiments described herein relate generally to editing of a document file.

### BACKGROUND

In creating a document, a space may be provided between texts in order to improve readability of the document and adjust the appearance of the document. However, provision of a space may increase the number of pages of the document and therefore increase the number of sheets required for print.

Thus, conventionally, a document editing apparatus or document editing software is provided which enables reduction in the number of pages by performing processing to delete a space of a print target document or reduce the size of the space. In the conventional document editing method, at the time of print, a user sets a degree to which the size of each space included in the document should be changed, and processing to delete the space based on the setting content.

### DESCRIPTION OF THE DRAWINGS

FIG. 1 shows a configuration of a system of an embodiment including an image forming apparatus and a client terminal.

FIG. 2 is a functional block diagram showing a first function of the image forming apparatus.

FIG. 3 shows an exemplary screen showing a document after an analysis that is displayed on a touch panel.

FIG. 4 shows an exemplary screen for setting a minimum value after deletion of a space.

FIG. 5 shows a data structure of a data table.

FIG. 6 is a functional block diagram showing a second function of the image forming apparatus.

FIG. 7 is a flowchart showing a flow of processing when a document file stored in association with space reduction setting information is printed by the image forming apparatus.

### DETAILED DESCRIPTION

In general, according to one embodiment, an image forming apparatus includes a file designating unit, a document file acquiring unit, a setting information acquiring unit, and a space processing control unit. The file designating unit designates a document file. The document file acquiring unit acquires the document file designated by the file designating unit, from a storage area. The setting information acquiring unit acquires setting information of processing to change the size of a space in the document file acquired by the document file acquiring unit, from a setting information storage area. The space processing control unit performs the processing to change the size of a space in the document file acquired by the document file acquiring unit, based on the setting information acquired by the setting information acquiring unit.

Hereinafter, embodiments will be described with reference to the drawings.

### First Embodiment

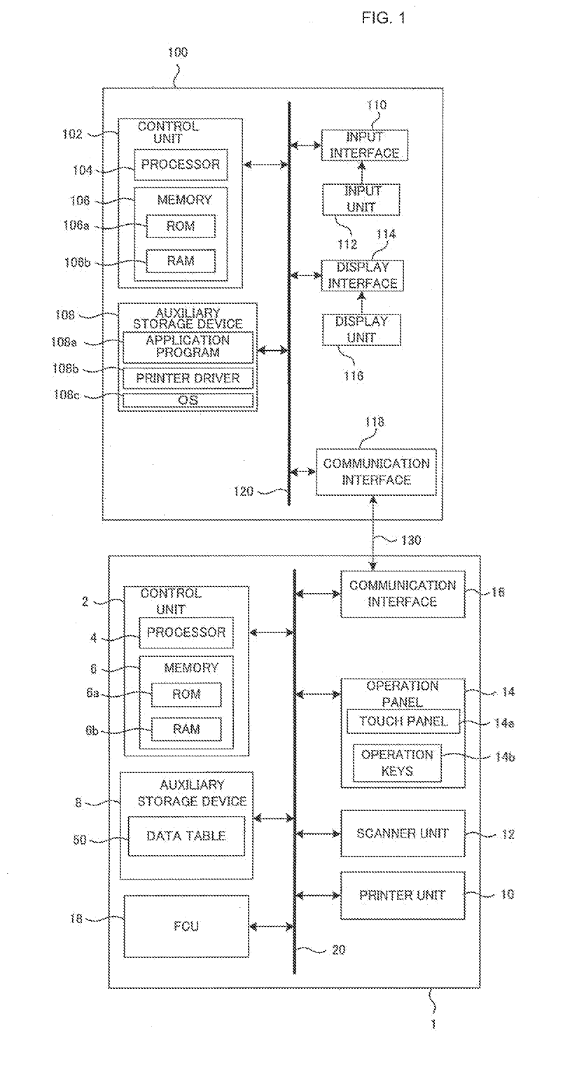

FIG. 1 shows a configuration of a system of this embodiment including an image forming apparatus 1 and a client terminal 100.

First, the image forming apparatus 1 includes a control unit 2, an auxiliary storage device 8, a printer unit 10, a scanner unit 12, an operation panel 14, a communication interface (communication I/F) 16, and a facsimile control unit (FCU) 18. The respective components of the image forming apparatus 1 are connected via a bus 20.

The control unit 2 functions with a processor 4, a memory 6, and an operating system (OS).

The processor 4 is a CPU (central processing unit) or an MPU (micro processing unit).

The memory 6 is, for example, a semiconductor memory. The memory 6 includes a ROM (read only memory) 6a to store a control program of the processor 4, and a RAM (random access memory) 6b to provide a temporary work area for the processor 4.

The control unit 2 controls the printer unit 10, the scanner unit 12, the operation panel 14, the communication interface 16, the FCU 18 and the like, based on the control program or the like stored in the ROM 6a or the auxiliary storage device 8.

The control unit 2 of this embodiment controls processing to adjust spaces, based on a space adjustment program for adjusting spaces of a document and managing information of the adjusted spaces.

The control unit 2 may further include various image processing functions. The control unit 2 may include an ASIC (application specific integrated circuit) to realize part or the whole of functions provided in the image forming apparatus 1.

The auxiliary storage device 8 stores application programs and the OS. The application programs include programs to execute functions provided in the image forming apparatus 1 such as a copy function, a print function, a scanner function, a facsimile function, and a network file function. The application programs further include an application for web client (web browser) and other applications. The auxiliary storage device 8 also stores the above space adjustment program for adjusting spaces of a document and managing information of the adjusted spaces.

The auxiliary storage device 8 also stores image data generated by the scanner unit 12 reading a document, data acquired from an external device connected with the communication interface 16, and the like. The auxiliary storage device 8 also temporarily stores a print job outputted by the client terminal 100 connected via a network 130, until the print is executed.

The auxiliary storage device 8 may be, for example, a magnetic storage device such as a hard disk drive, an optical storage device, a semiconductor storage device (flash memory or the like), or any combination of these storage devices. The auxiliary storage device 8 properly saves software updates, protected electronic documents, text data, account information, policy information and the like.

The printer unit 10 forms, on a sheet, an image of a document read by the scanner unit 12 or an image corresponding to data sent from an external computer such as the client terminal 100 via the network 130.

The scanner unit 12 includes a built-in scanning and reading unit which reads a document in the form of an image, a document placing table, and an automatic document feeder which carries a document to a reading position. The scanning and reading unit of the scanner unit 12 reads a document set on the document placing table or the automatic document feeder.

The operation panel 14 includes a touch panel 14a and various operation keys 14b. The touch panel 14a displays setting contents about print conditions, for example, sheet size, the number of sheets of copy, print density setting, or finishing (stitching, folding) and the like. The operation keys 14b include, for example, ten keys, a reset key, a stop key, a start key and the like. The user can give instructions to execute various kinds of processing or designate an operation to set print conditions or an operation to change the setting contents of the print conditions, by inputting these instructions from the touch panel 14a or the operation keys 14b.

In this embodiment, processing to adjust the size of a space in a document can be carried out by an operation input of the touch panel 14a or the operation keys 14b on the operation panel 14.

The communication interface 16 is an interface which connects the image forming apparatus 1 with the client terminal 100 via the network 130. FIG. 1 shows a configuration in which only the client terminal 100 is connected to the image forming apparatus 1. However, other external devices can be connected with the image forming apparatus 1 via the communication interface 16. The external device may be, for example, an external storage device such as a flash memory. The image forming apparatus 1 can also carry out so-called direct print in which image data is acquired from the external storage device and the acquired image is printed.

The communication interface 16 connects the external device such as the client terminal 100 with the image forming apparatus 1 via proper wireless communication or wired communication conforming to IEEE 802.15, IEEE 802.11, IEEE 802.3, IEEE 1284, IrDA and the like, for example, Bluetooth (trademark registered), wireless LAN, infrared connection, and optical connection. The communication interface 16 includes a buffer and temporarily holds part or the whole of received data in the buffer.

The control unit 2 communicates with PCs (personal computers) such as the client terminal 100 or other external devices via the communication interface 16 and the network 130.

The facsimile control unit (FCU) 18 control facsimile transmission and reception in the image forming apparatus 1.

Next, the client terminal 100 includes a control unit 102, an auxiliary storage device 108, an input interface (input I/F) 110, an input unit 112, a display interface (display I/F) 114, a display unit 116, and a communication interface (communication I/F) 118. The respective components of the client terminal 100 are connected via a bus 120. As the client terminal 100, a PC (personal computer), mobile terminal or tablet terminal or the like may be used.

The control unit 102 functions with a processor 104 made up of a CPU (central processing unit) or an MPU (micro processing unit), a memory 106, and an operating system (OS) 108c.

The processor 104 executes an application program 108a stored in the auxiliary storage device 108. The processor 104 also executes a printer driver 108b and thus executes processing to generate a print job based on print target data. The processor 104 executes processing to transmit the generated print job to the image forming apparatus 1 via the communication interface 118 and the network 130.

The memory 106 is, for example, a semiconductor memory, and includes a ROM (read only memory) 106a to store a control program of the processor 104 and a RAM (random access memory) 106b to provide a temporary work area for the processor 104.

The auxiliary storage device 108 stores the application program 108a, the printer driver 108b, and the OS (operating system) 108c as the control program of the processor 104.

The application program 108a operates as software of the OS 108c. The application program 108a includes a web application in addition to general software such as document creation software.

The printer driver 108b is a device driver controlling the image forming apparatus 1 in accordance with a print instruction from the application program 108a, and operates as software of the OS 108c.

The auxiliary storage device 108 with the above functions may be, for example, a hard disk drive or another magnetic storage device, an optical storage device, a semiconductor storage device such as a flash memory, or any combination of these storage devices.

The input interface 110 is an interface to connect the input unit 112. The input unit 112 is an input device such as a keyboard device, a pointing device like a mouse, or a touch panel.

The display interface 114 is an interface to connect the display unit 116. The display interface 114 receives data to be displayed on the display unit 116 from other components connected to the bus 120. The display interface 114 then outputs the display data to the display unit 116. The display unit 116 displays the outputted display data. The display unit 116 is, for example, a display or a touch panel attached to a PC or the like.

The communication interface 118 is an interface to connect with an external device. The communication interface 118 communicates with the external device (for example, the image forming apparatus 1 or other PCs or USB devices) via the network 130 by proper wireless communication or wired communication conforming to IEEE 802.15, IEEE 802.11, IEEE 802.3, IEEE 1284, IrDA and the like, for example, Bluetooth, wireless LAN, infrared connection, and optical connection. The control unit 102 communicates with the image forming apparatus 1, other PCs, USB devices and other external devices via the communication interface 118.

Next, functions of the image forming apparatus 1 will be described.

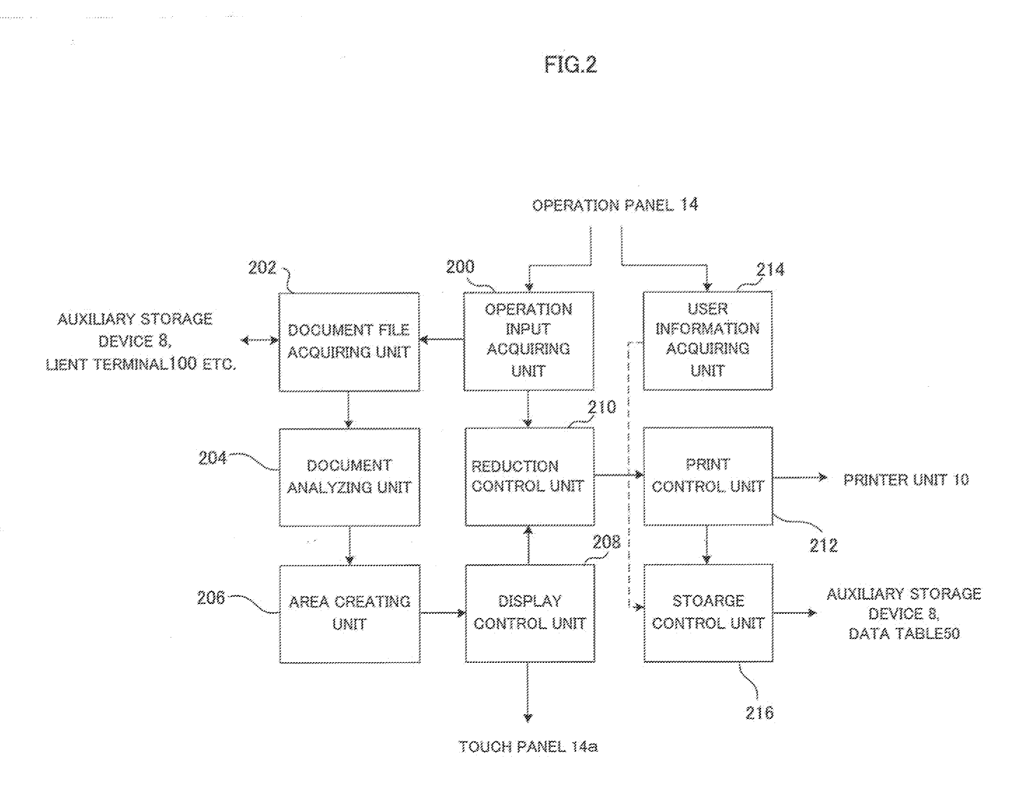

First, a function (first function) of the image forming apparatus 1 to provide a setting of processing to reduce a space and then execute processing to print a document on which the space reduction processing is carried out based on that setting will be described. FIG. 2 is a functional block diagram showing the first function of the image forming apparatus 1 of this embodiment. This function of the image forming apparatus 1 is realized by the processor 104 executing the above space adjustment program. However, this function may be partly or entirely realized by the ASIC as a processor.

In this embodiment, a “space” is a blank area in a document provided between texts or images in an area where the texts or the images are shown within a page, in order to make the document easier to read or to adjust the appearance. Therefore a “space” excludes margins set at the top, bottom, left and right of the page unless otherwise stated in the embodiment.

For the first function, the image forming apparatus 1 has an operation input acquiring unit 200, a document file acquiring unit 202, a document analyzing unit 204, an area creating unit 206, a display control unit 208, a reduction control unit 210, a print control unit 212, a user information acquiring unit 214, and a storage control unit 216.

The operation input acquiring unit 200 acquires various operation inputs from the operation panel 14 (the touch panel 14a and the operation keys 14b). In this embodiment, the operation input acquiring unit 200 acquires an operation input for processing to adjust a space from the operation panel 14. In addition, the operation input acquiring unit 200 also acquires instructions to execute processing such as copy, scan or facsimile and operation inputs to set conditions for such processing, which are given on the operation panel 14.

The document file acquiring unit 202 acquires a processing target document file to be printed with a reduced space. Specifically, the user gives an operation input to designate a processing target document file on the operation panel 14, and the document file acquiring unit 202 acquires the designated document file. The processing target document file may be, for example, a document file stored in advance in the auxiliary storage device 8 of the image forming apparatus 1 or a file acquired as a print job from the client terminal 100 via the network 130.

The document analyzing unit 204 analyzes the structure of the processing target document file acquired by the document file acquiring unit 202. The document analyzing unit 204 analyzes areas within each page of the document and analyzes which one of a text area, an image area and a space area each area pertains to.

The area creating unit 206 generates a space object (hereinafter, the space object is referred to as a space container) in an area analyzed as the space area. Thus, the space area is recognized as an object and processing to change the size of the space container or delete the space container is enabled.

The display control unit 208 displays, on the touch panel 14a, the document analyzed by the document analyzing unit 204 and having the space container generated in the space area by the area creating unit 206.

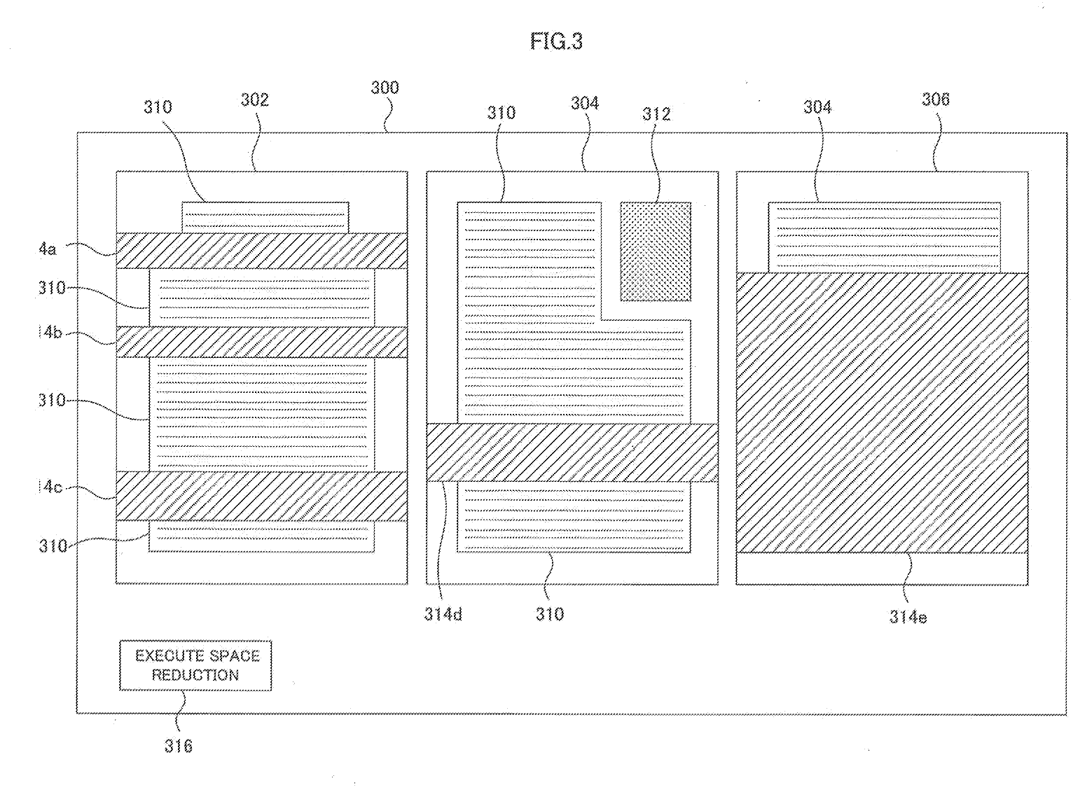

Here, FIG. 3 shows an example of a screen 300 showing the document after analysis, displayed on the touch panel 14a. In the screen 300, rectangular areas in which broken lines are shown are text areas 310. An area filled with dots is an image area 312. Areas between the text areas 310 and shaded by slant lines are the space containers corresponding to the space areas. The document shown in FIG. 3 contains three pages from page 1 302 to page 3 306 and includes five space containers 314a to 314e. As the user carries out an operation input to press a space reduction execution button 316, the image forming apparatus 1 can be instructed to execute processing to reduce spaces.

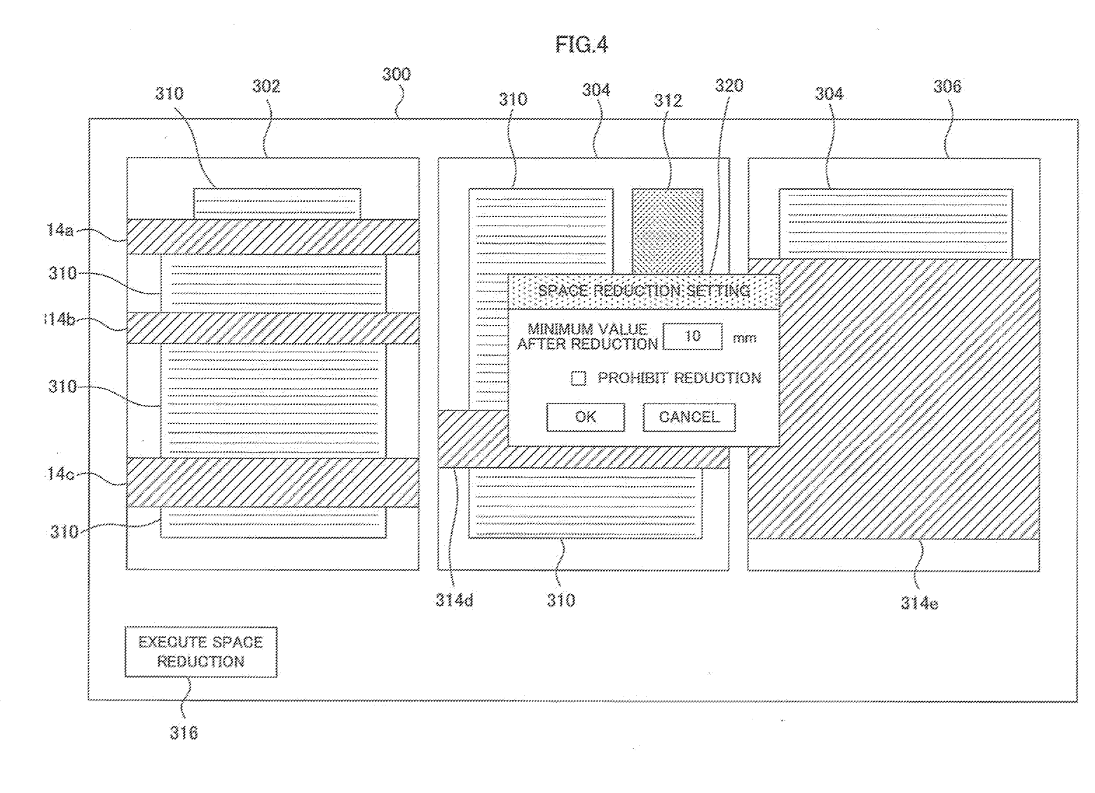

The reduction control unit 210 performs processing to reduce the height of the space containers in the document when the instruction to execute the processing to reduce spaces is given. The processing to reduce spaces is executed based on a minimum value of space after reduction that is set for each space. Here, FIG. 4 shows an exemplary screen for setting the minimum value after space reduction. FIG. 4 shows that a dialog box 320 with a title of space reduction setting is displayed in the screen 300. This dialog box 320 is displayed as the user operates the touch panel 14a or the like and selects the space container (by way of example, the dialog box 320 in FIG. 4 is displayed by selecting the space container 314d).

In this dialog box 320, the minimum value of the size of the space after reduction in the case of reducing the space container can be inputted. For example, when the minimum value after reduction is set to 10 mm as shown in FIG. 4 and the current height of the space container 314d is 20 mm, the space container 314d is reduced to a range of 10 mm or greater to smaller than 20 mm. Moreover, in the dialog box 320, when reduction of the selected space container is not desired, prohibition of reduction can be set by checking a check box for reduction prohibition. The dialog box 320 may also enable designation of a height of the space after reduction. When the height of the space after reduction is designated, the space is reduced to the designated height by the reduction.

As the user gives an operation input to press the space reduction execution button 316 in the screen 300, the reduction control unit 210 executes processing to reduce each space container based on the condition that is set in the dialog box.

The print control unit 212 controls processing to print a print target document. In this embodiment, the print control unit 212 controls processing to print a document on which space reduction is executed by the reduction control unit 210.

Depending on the amount of reduction of the space, a document can be printed in a smaller number of pages than before the space reduction. For example, in the case of the document shown in FIG. 3 and FIG. 4, if the total of the height reductions of the spaces is greater than the height of the text area in the final page 306, all the texts in the page 306 shift to the previous page 304 and therefore the page 306 is not necessary. Thus, in this case, the number of pages can be reduced.

The user information acquiring unit 214 acquires user information that identifies the user to which the processing target document file belongs. The image forming apparatus 1 of this embodiment can store and manage an original file (the file before space reduction) of the document file printed with reduced spaces in association with the setting condition for the space reduction, using the storage control unit 216. In this case, search for and management of the file become easier by storing and managing the file in association with the user information. Particularly, when the image forming apparatus 1 is used by plural users, managing of the file in association with the user information is preferable.

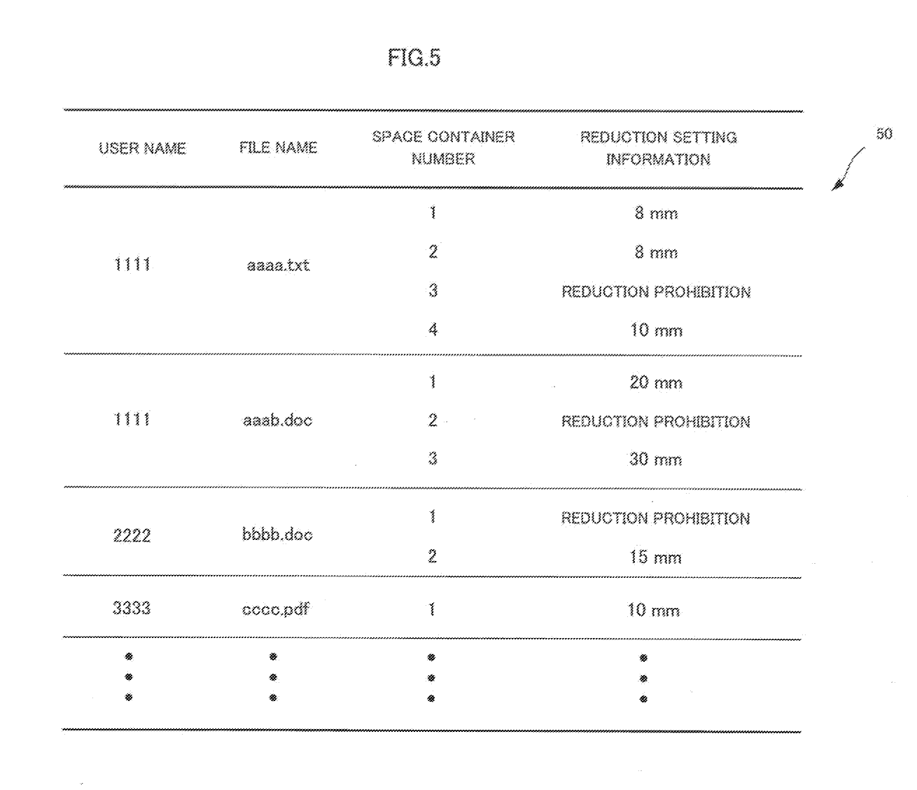

The storage control unit 216 causes a print target document file to be stored in the auxiliary storage device 8 and registers the document file in a data table 50 (setting information storage area) in the auxiliary storage device 8 in association with setting information indicating setting conditions for space reduction (reduction setting information), the user information, and file name. Here, FIG. 5 shows the data structure of the data table 50. As shown in FIG. 5, in the data table 50, the user information and the file name as information specifying a document file, a space container number as space designation information, and the reduction setting information indicating setting contents of space reduction are registered in association with each other. Numerical values shown as the reduction setting information in FIG. 5 are minimum values of the space height where reduction is executed.

According to the data table 50 shown in FIG. 5, for example, four space containers 1 to 4 exist in a document file aaaa.txt of a user 1111. A minimum value 8 mm that is set for the space containers 1 and 2, reduction prohibition that is set for the space container 3, and a minimum value 10 mm that is set for the space container 4 are registered in association the document file name.

The foregoing are the functional blocks to realize the processing to provide a setting of space reduction, reduce spaces of a document based on the setting content, and store the space-reduced document file in association with setting information of the reduction.

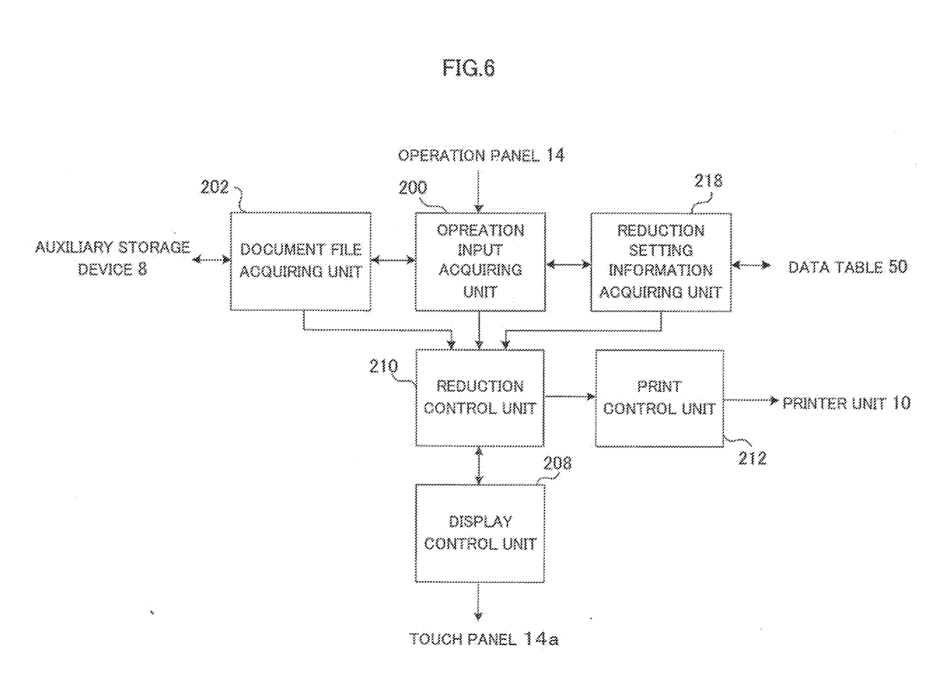

Next, a function (second function) of the image forming apparatus 1 to realize processing to print a document file stored in association with setting information of reduction executed in the past, while reflecting the setting content of the associated reduction on the print, will be described. FIG. 6 is a functional block diagram showing the second function provided in the image forming apparatus 1 of this embodiment. The function of the image forming apparatus 1 is realized by the processor 104 executing the above space adjustment program. However, this function may be partly or entirely realized by the ASIC as a processor.

For the second function, the image forming apparatus 1 has the operation input acquiring unit 200, the document file acquiring unit 202, a reduction setting information acquiring unit 218, the reduction control unit 210, the display control unit 208, and the print control unit 212.

The operation input acquiring unit 200 acquires an operation input from the operation panel 14. Specifically, the operation input acquiring unit 200 acquires, from the operation panel 14, an operation input by the user to designate a print target document file as a file designating unit and an operation input to give an instruction to print the designated document file.

The document file acquiring unit 202 acquires the designated document file from the auxiliary storage device 8, based on the operation input to designate the document file acquired by the operation input acquiring unit 200. The operation input to designate the document file may be an operation to designate the file name or an operation to designate the file in a list.

The reduction setting information acquiring unit 218 accesses the data table 50, and when the designated file is associated with reduction setting information, the reduction setting information acquiring unit 218 acquires the associated reduction setting information.

The reduction control unit 210 performs space reduction in the document file associated with the reduction setting information, based on the setting content corresponding to the reduction setting information.

When the document file designated by the user as a print target file is associated with the reduction setting information, the display control unit 208 displays, on the touch panel 14a, a confirmation screen for confirming whether to apply space reduction based on the reduction setting information to printing of the designated document file. In this case, the display control unit 208 may display, on the touch panel 14a, the setting content of the reduction corresponding to the reduction setting information associated with the print target file (that is, how each space should be reduced).

Moreover, when the user designates a print target document file, the display control unit 208 may display a list of document files stored in the auxiliary storage device 8.

The print control unit 212 controls processing to print the document to which the space reduction based on the setting content associated with the designated document file is applied by the reduction control unit 210.

The foregoing are the functional blocks to realize the second function of the image forming apparatus 1 of this embodiment. When an operation input to give an instruction not to apply reduction is provided on the confirmation screen for confirming whether to apply space reduction to printing, displayed by the display control unit 208, additional setting of space reduction for the document of the document file may be enabled. In this case, processing to provide setting of space reduction, carry out reduction based on the setting content and then print the document may be executed by the functional blocks of the first function shown in FIG. 2.

With the above function of the image forming apparatus 1 according to this embodiment, a document file is stored in association with space reduction setting information and therefore in the case of printing the same document file again, the space reduction that is set in the past can be applied to printing of the document file. Thus, in the case of printing the document file with the same space reduction as in the previous print, the same space reduction setting need not to be carried out again and processing to change the size of spaces can be carried out efficiently.

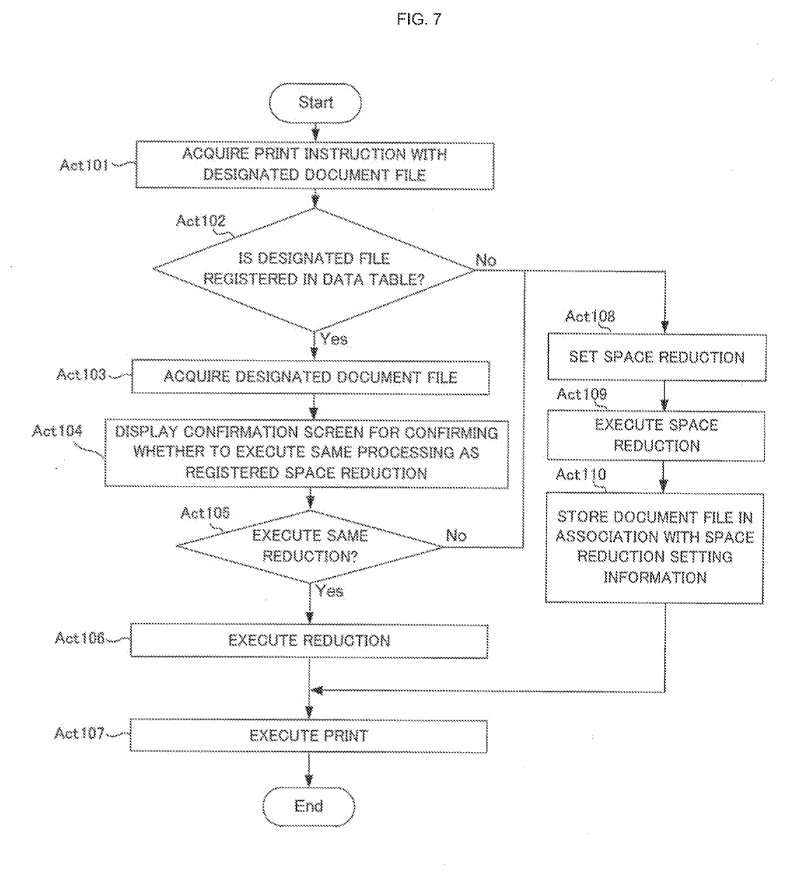

Next, a flow of processing based on the second function of this embodiment by the image forming apparatus 1 of this embodiment will be described. FIG. 7 is a flowchart showing a flow of processing at the time of printing, in the image forming apparatus 1, a document file stored in association with space reduction setting information.

First, the operation input acquiring unit 200 acquires an operation input to give an instruction to designate and print a document file (ACT 101). The operation input acquiring unit 200 acquires a file name of the document file, user information associated with the document file, and the like.

Next, the reduction setting information acquiring unit 218 determines whether the designated document file is registered in the data table 50 or not (ACT 102).

If the document file is registered in the data table 50 (Yes in ACT 102), the document file acquiring unit 202 acquires the designated document file from the auxiliary storage device 8 (ACT 103).

Then, the display control unit 208 causes the touch panel 14a to display a setting content corresponding to space reduction setting information acquired by the reduction setting information acquiring unit 218, and also displays a screen for confirming whether to carry out the same reduction as registered space reduction that is executed in the previous print processing (ACT 104).

If the operation input acquiring unit 200 acquires an operation input from the user to give an instruction to carry out the same reduction on the display screen (Yes in ACT 105), the reduction control unit 210 carries out space reduction of the designated document file, based on the reduction setting information acquired from the data table 50 by the reduction setting information acquiring unit 218 (ACT 106).

Then, the print control unit 212 causes the printer unit 10 to print the document to which the reduction is applied (ACT 107).

Meanwhile, if the designated document file is not registered in the data table 50 (No in ACT 102), that is, if an instruction to print a new file with no space reduction executed in the past is given, processing to set space reduction is carried out by the functional blocks of the first function shown in FIG. 2 (the document file acquiring unit 202, the document analyzing unit 204, the area creating unit 206, the display control unit 208, the reduction control unit 210 and the like) (ACT 108). The reduction control unit 210 executes space reduction based on the setting content of the space reduction thus set (ACT 109). Then, if an operation input to store the setting content of the set reduction is given, the storage control unit 216 of FIG. 2 registers the processing target document file in association with the reduction setting information of the space reduction in the data table 50 (ACT 110). Specifically, the storage control unit 216 stores the document file in the auxiliary storage device 8 and also registers the file name of the document file, user information, space container number, and reduction setting information indicating the setting content of space reduction that is set for each space container, in association with each other in the data table 50.

The print control unit 212 causes the printer unit 10 to print the document in which reduction is executed based on the setting content thus set (ACT 107).

Meanwhile, if the operation input acquiring unit 200 acquires an operation input to give an instruction not to carry out the same reduction, as an operation put on the confirmation screen displayed in ACT 104 (No in ACT 105), ACT 108, ACT 109 and ACT 110 are executed similarly.

The foregoing is the flow of processing on a document file for which space reduction is set, in the image forming apparatus 1 of this embodiment.

The flow of processing shown in FIG. 7 described that processing to store the document file is carried out in ACT 110 and print is carried out subsequently. However, the order is not limited to this example. After space reduction is carried out, print may be carried out first and storage processing may be carried out subsequently. Alternatively, storage processing and print may be carried out in parallel.

In the above embodiment, the user operates the image forming apparatus 1 to set space reduction for a document file and store the content of the space reduction in a predetermined storage area, and the next time the same document is printed in the image forming apparatus 1, space reduction is carried out, applying the stored setting content. However, possible configurations are not limited to this example. For example, the client terminal 100 outputting a print job to the image forming apparatus 1 may include the function that is described as the functions of the image forming apparatus 1 in the embodiment. For example, when the printer driver is started up or the like, the client terminal 100 may be able to set space reduction based on the above first function. Moreover, when print is carried out with space reduction, setting information corresponding to the setting content of the space reduction may be stored in the auxiliary storage device 108 of the client terminal 100, and in the case of printing the same document file again, the above second function may be realized in the client terminal 100. Thus, the space reduction that is previously carried out can be directly applied to the document file. Then, a print job to print the document file to which the space reduction is applied may be outputted to the image forming apparatus 1, thus enabling print of the document to which the space reduction is applied. Thus, where even a computer such as the client terminal 100 includes the functions as described in the embodiment, a space-reduced document can be printed easily, using the setting content of space reduction that is previously executed.

A document file and setting information of space reduction may also be stored in a storage area of an external server or the like. The image forming apparatus 1 may access the server, acquire the document file and the setting information of space reduction associated with the document file, and execute space reduction of the document file. Thus, similar processing to the processing described in the embodiment can be carried out.

In the embodiment, the processing for the image forming apparatus 1 to reduce spaces is described. However, possible processing is not limited to this example. Enlargement processing to enlarge spaces may be set and the processing to enlarge spaces may be carried out, as needed. Moreover, processing to delete spaces may be set and the processing to delete spaces may be carried out.

As described above in detail, according to some embodiments, an image forming apparatus that can efficiently execute space reduction of a document file can be provided.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus comprising:
a file designating unit which designates a document file;
a document file acquiring unit which acquires the document file designated by the file designating unit, from a storage area;
a setting information acquiring unit which acquires setting information of processing to change the size of a space in the document file acquired by the document file acquiring unit, from a setting information storage area; and
a space processing control unit which performs the processing to change the size of a space in the document file acquired by the document file acquiring unit, based on the setting information acquired by the setting information acquiring unit.

2. The apparatus of claim 1, wherein file designation information of the document file designated by the file designating unit includes user information which identifies a user associated with the document file.

3. The apparatus of claim 1, wherein the setting information includes space designation information which designates a space in a document.

4. The apparatus of claim 1, further comprising a display control unit which controls processing to display a confirmation screen for confirming whether or not to execute the processing to change the size of a space based on the setting information with respect to the document file designated by the file designating unit.

5. The apparatus of claim 4, wherein when an operation input which gives an instruction to execute the processing to change the size of a space is given on the confirmation screen displayed by the display control unit, the space processing control unit executes the processing to change the size of a space based on the setting information with respect to the designated document file.

6. The apparatus of claim 1, further comprising:
an operation input unit which sets the processing to change the size of a space in a document of the document file; and
a storage control unit which stores the document file and the setting information corresponding to an operation input by the operation input unit in association with each other in the setting information storage area.

7. The apparatus of claim 6, further comprising a user information acquiring unit which acquires user information identifying a user,
wherein the storage control unit stores the document file acquired by the document file acquiring unit, the setting information of the processing to change the size of a space corresponding to the operation input by the operation input unit, and the user information acquired by the user information acquiring unit, in association with each other in the setting information storage area.

8. The apparatus of claim 1, wherein the processing to change the size of a space in the document file is processing to reduce the space.

9. The apparatus of claim 1, further comprising an image formation control unit which controls image formation of a document in which the size of a space is changed by the space processing control unit.

10. A document editing method comprising:
acquiring file designation information which designates a document file;
acquiring the document file corresponding to the file designation information from a predetermined storage area;
acquiring setting information of processing to change the size of a space in a document of the acquired document file, from a setting information storage area; and
performing the processing to change the size of a space in the acquired document file, based on the setting information.

11. The method of claim 10, wherein the file designation information includes user information which identifies a user associated with the document file.

12. The method of claim 10, wherein the setting information includes space designation information which designates a space in the document.

13. The method of claim 10, wherein processing to display a confirmation screen for confirming whether or not to execute the processing to change the size of a space based on the setting information with respect to the document file designated by the file designation information is carried out.

14. The method of claim 13, wherein when an operation input which gives an instruction to execute the processing to change the size of a space is given on the displayed confirmation screen, the processing to change the size of a space based on the acquired setting information with respect to the document file designated by the file designation information is executed.

15. The method of claim 10, wherein an operation input to set the processing to change the size of a space in the document of the document file is acquired, and
the acquired document file and setting information of the processing to change the size of a space corresponding to the acquired operation input are stored in association with each other in the setting information storage area.

16. The method of claim 15, wherein user information identifying a user is acquired, and
the acquired document file, the setting information of the processing to change the size of a space corresponding to the acquired operation input, and the acquired user information are stored in association with each other in the setting information storage area.

17. The method of claim 10, wherein the processing to change the size of a space in the document is processing to reduce the space.

18. The method of claim 10, wherein processing to form an image of a document in the acquired document file in which the processing to change the size of a space is executed is controlled, based on the acquired setting information.
